(19) United States
(12) Patent Application Publication
(10) Pub. No.: US 2026/0336753 A1
(43) Pub. Date: Oct. 29, 2026

(54) ELECTRIC SNOWMOBILE WITH BATTERY PACK INSULATING COVER

(71) Applicant: BOMBARDIER RECREATIONAL PRODUCTS INC., Valcourt (CA)

(72) Inventors: Thomas DRIANT, Saint-Francois-Xavier-de-Brompton (CA); Guillaume MORIN, Racine (CA); Christopher DUFOUR-LANDRY, Sherbrooke (CA)

(21) Appl. No.: 19/115,150

(22) PCT Filed: Oct. 2, 2023
(86) PCT No.: PCT/IB2023/059867

§ 371 Date: Mar. 25, 2025

Related U.S. Application Data
(60) Provisional application No. 63/412,211, filed on Sep. 30, 2022.

(51) Int. Cl. B62M 27/02; B60L 50/60; H01M 10/42; H01M 10/625; H01M 10/656; H01M 10/658; H01M 50/204; H01M 50/249; H01M 50/262; H01M 50/273

(52) U.S. Cl. CPC B62M 27/02; H01M 10/425; H01M 10/625; H01M 10/656; H01M 10/658; H01M 50/204; H01M 50/249; H01M 50/262; H01M 50/273; B60L 50/60; B62M 2027/023; B62M 2027/027; B62M 2027/028; H01M 2220/20

(57) ABSTRACT

Anelectric snowmobile has: a frame having a tunnel; a seat connected to the tunnel; at least one ski operatively connected to the frame; a handlebar operatively connected to the at least one ski; a drive track disposed at least in part under the tunnel; an electric motor supported by the frame, the electric motor being operatively connected to the drive track; and a battery pack electrically connected to the electric motor. The battery pack has: a housing connected to the frame; and a plurality of battery cells housed in the housing. The electric snowmobile also has: an insulating cover disposed around the housing to thermally insulate the battery pack; and fairings connected to the frame, the insulating cover being disposed between the fairings and the housing.

WO

### CROSS-REFERENCE

The present application claims priority to U.S. Provisional Patent Application No. 63/412,211, filed Sep. 30, 2022, the entirety of which is incorporated herein by reference.

### TECHNICAL FIELD

The present technology relates to thermal insulation of battery packs of electric snowmobiles.

### BACKGROUND

Many recent vehicles are powered by one or more electric motors instead of an internal combustion engine. Over the life of a vehicle, an electric vehicle will typically pollute less than a comparable vehicle having an internal combustion engine. Electric vehicles also tend to be quieter than their gas-powered counterparts.

Snowmobiles could also benefit from these advantages of having an electric motor. However, due to the relatively small size of a snowmobile, the need for the snowmobile to float over snow, and the lack of charging infrastructures in many areas where snowmobiles are used, the electrification of snowmobiles has many challenges not faced by other vehicles such as cars.

One such challenge is the low temperatures in which snowmobiles operates. Low temperatures negatively affect the capacity of battery packs, and therefore the driving range of an electric snowmobile.

Therefore, there is a need for an electric snowmobile that at least partially protects the battery pack from loss of capacity due to low temperatures.

### SUMMARY

It is an object of the present technology to ameliorate at least some of the inconveniences present in the prior art.

According to an aspect of the present technology, there is provided an electric snowmobile having: a frame having a tunnel; a seat connected to the tunnel; at least one ski operatively connected to the frame; a handlebar operatively connected to the at least one ski; a drive track disposed at least in part under the tunnel; an electric motor supported by the frame, the electric motor being operatively connected to the drive track; and a battery pack electrically connected to the electric motor. The battery pack has: a housing connected to the frame; and a plurality of battery cells housed in the housing. The electric snowmobile also has: an insulating cover disposed around the housing to thermally insulate the battery pack; and fairings connected to the frame, the insulating cover being disposed between the fairings and the housing.

According to some embodiments of the present technology, the insulating cover is disposed around a majority of the housing.

According to some embodiments of the present technology, an inner surface of the insulating cover is congruous or generally congruous with an outer surface of the housing.

According to some embodiments of the present technology, a maximum distance between the inner surface of the insulating cover and the outer surface of the housing is less than 5 centimeters. The maximum distance is measured normal to the outer surface of the housing.

According to some embodiments of the present technology, the insulating cover defines at least one aperture.

According to some embodiments of the present technology, a battery mount is connected to the frame; and a battery mount fastener connects the battery mount to the housing. The at least one aperture includes a battery mount aperture. At least one of the battery mount and the battery mount fastener extends through the battery mount aperture.

According to some embodiments of the present technology, a portion of the insulating cover is held between the battery mount and the housing.

According to some embodiments of the present technology, a steering column operatively connects the handlebar to the at least one ski. The frame has: a steering column support bracket supporting the steering column; and a battery bracket connected between the steering column support bracket and the housing. The at least one aperture includes a battery bracket aperture. The battery bracket extends through the battery bracket aperture.

According to some embodiments of the present technology, the electric snowmobile also has a heat exchanger; and a conduit fluidly connecting the heat exchanger to the battery pack. The at least one aperture includes a conduit aperture. The conduit extends through the conduit aperture.

According to some embodiments of the present technology, the conduit is a first conduit. The electric snowmobile also has: an inverter electrically connected to the plurality of battery cells, the first conduit fluidly connecting the inverter to the battery pack; and a second conduit fluidly connecting the heat exchanger to the inverter. The inverter defines a third conduit fluidly connecting the second conduit to the first conduit.

According to some embodiments of the present technology, the inverter is mounted to the housing.

According to some embodiments of the present technology, the battery pack has a pressure valve connected to the housing. The pressure valve is configured for selectively opening to release gases from inside the housing. The battery pack also has a cover connected to the housing. The cover covers the pressure valve. A space is defined between the housing and the cover. The at least one aperture is an aperture surrounding the cover. A wall of the insulating cover defining the aperture is spaced from an edge of the cover to define a gap therebetween.

According to some embodiments of the present technology, an inverter is mounted to the housing; an electric connector electrically connects the inverter to the plurality of battery cells; and an inverter fastener connects the inverter to the housing. The at least one aperture includes an inverter aperture. At least one of the inverter, the electric connector and the inverter fastener extends through the inverter aperture.

According to some embodiments of the present technology, the electric connector and the inverter fastener extend through the inverter aperture.

According to some embodiments of the present technology, the electric snowmobile also has a heat exchanger; a first conduit fluidly connecting the heat exchanger to the inverter; and a second conduit fluidly connecting the inverter to the battery pack. The inverter defines a third conduit fluidly connecting the second conduit to the first conduit. The second conduit extends through the inverter aperture.

According to some embodiments of the present technology, a steering column operatively connects the handlebar to the at least one ski. The insulating cover defines at least one recess. The at least one recess is configured for receiving a portion of the steering column when the steering column is turned to steer the snowmobile

According to some embodiments of the present technology, the insulating cover has a first part and a second part separate from the first part. The first part is adjacent to the second part. The first part defines a first cavity receiving a first portion of the battery pack therein. The second part defines a second cavity receiving a second portion of the battery pack therein.

According to some embodiments of the present technology, the first and second parts of the insulating cover are longitudinally split from each other. The first part is a left part of the insulating cover. The second part is a right part of the insulating cover.

According to some embodiments of the present technology, the insulating cover has a variable thickness.

According to some embodiments of the present technology, the insulating cover is made of polyurethane foam.

According to some embodiments of the present technology, the frame includes a subframe connected to the tunnel and disposed in front of the tunnel. The battery pack is disposed at least in part in the subframe. The housing is connected to the subframe.

According to some embodiments of the present technology, at least a portion of the subframe extends below the battery pack and the insulating cover.

For purposes of this application, terms related to spatial orientation when referring to the vehicle orientation and positioning of its components such as forwardly, rearwardly, left, and right are as they would normally be understood by a driver of the vehicle sitting thereon in a normal riding position.

Embodiments of the present technology each have at least one of the above-mentioned aspects, but do not necessarily have all of them.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of an electric snowmobile;

FIG. 2 is a perspective view, taken from a rear, right side of the snowmobile of FIG. 1, with the drive track being removed;

FIG. 3 is a perspective view, taken from a front, left side of a frame and some internal components the snowmobile of FIG. 1;

FIG. 4 is a perspective view, taken from a front, right side of the frame and internal components of FIG. 3, with a plug of an electric vehicle charger shown disconnected from a charging port of the snowmobile;

FIG. 5 is a top plan view of the frame and internal components of FIG. 3;

FIG. 6 is a left side elevation view of the frame and internal components of FIG. 3;

FIG. 7 is a right side elevation view of the frame and internal components of FIG. 3;

FIG. 8 is a partially exploded perspective view, taken from a rear, right side of the internal components of FIG. 3 and of a secondary battery;

FIG. 9 is a perspective view, taken from a front, left side of the frame and the internal components of FIG. 3 with a battery mount shown disconnected from the frame and a battery pack of the snowmobile of FIG. 1;

FIG. 10 is a close-up, perspective view, taken from a front, left side of a brace assembly, a portion of a steering column and an upper portion of the battery pack of the snowmobile of FIG. 1;

FIG. 11 is a perspective view taken from a rear, right side of the battery pack, an insulating cover and an inverter of the snowmobile of FIG. 1;

FIG. 12 is a perspective view taken from a rear, right side of the battery pack, the insulating cover and the inverter of FIG. 11, with the inverter shown removed from the battery pack;

FIG. 13 is a perspective view taken from a rear, right side of the battery pack, and the insulating cover of FIG. 11;

FIG. 14 is a perspective view taken from a rear, right side of the battery pack, and the insulating cover of FIG. 13, with the insulating cover shown removed from the battery pack;

FIG. 15 is a perspective view taken from a rear, left side of the battery pack, and the insulating cover of FIG. 13, with the insulating cover shown removed from the battery pack;

FIG. 16 is an exploded perspective view, taken from a front, left side of a left part of the insulating cover and of the corresponding battery mount;

FIG. 17 is a lateral cross-section of the battery pack, the insulating cover and the inverter of FIG. 11;

FIG. 18 is a left side elevation view of the battery pack and an alternative embodiment of the insulating cover;

FIG. 19 is a right side elevation view of the battery pack and the insulating cover of FIG. 18;

FIG. 20 is a perspective view, taken from a rear, left side of the battery pack and the insulating cover of FIG. 18, and of a battery mount shown disconnected from the battery pack;

FIG. 21 is a front elevation view of the battery pack, the insulating cover and the battery mount of FIG. 20, with the battery mount connected to the battery pack, and of the steering column of the snowmobile of FIG. 1;

FIG. 22 is a perspective view, taken from a top, front view, of the battery pack, the insulating cover, the battery mount and the steering column of FIG. 21, with the steering column being steered in a direction for making the snowmobile of FIG. 1 make a left turn;

FIG. 23 is a slice of the battery pack, the insulating cover and the battery mount of FIG. 21, taken through plane 23-23 of FIG. 18;

FIG. 24 is a slice of the battery pack, the insulating cover and the battery mount of FIG. 21, taken through plane 24-24 of FIG. 18;

FIG. 25 is a slice of the battery pack and the insulating cover of FIG. 21, taken through plane 25-25 of FIG. 19; and

FIG. 26 is a slice of the battery pack and the insulating cover of FIG. 21, taken through plane 26-26 of FIG. 19.

### DETAILED DESCRIPTION

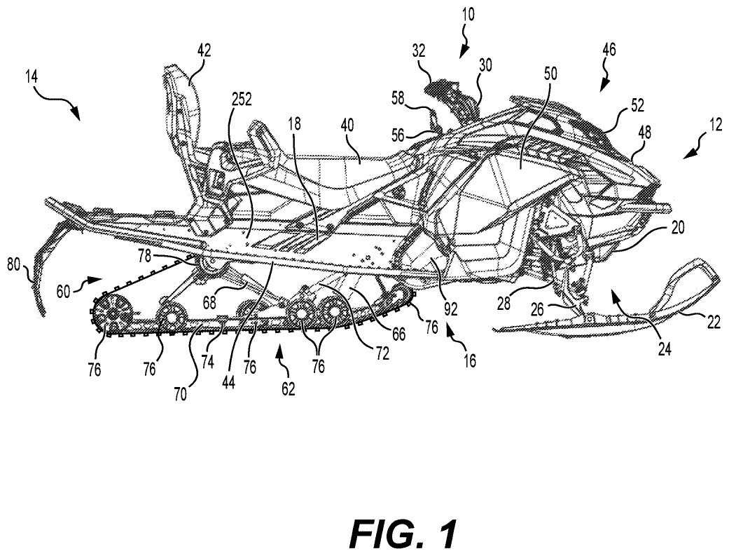

With reference to FIGS. 1 to 5, a snowmobile 10 in accordance with an embodiment of the present technology will be described herein. The snowmobile 10 has a front end 12 and a rear end 14, which are defined consistently with the forward travel direction of the snowmobile 10. The snowmobile 10 has a frame 16 for supporting the various components of the snowmobile 10. The frame 16 includes a tunnel 18 and a subframe 20 connected to the tunnel 18 and being disposed in front of the tunnel 18. The frame 16 will be described in more detail below.

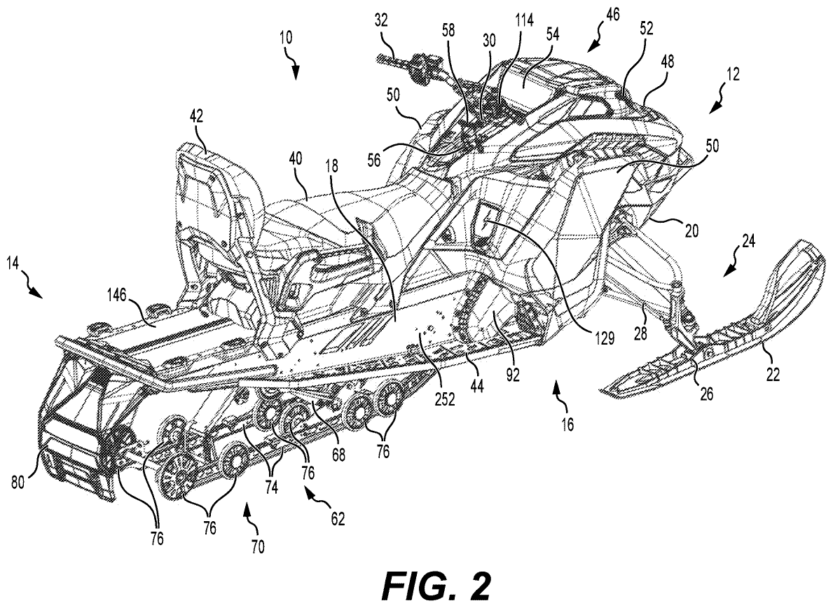

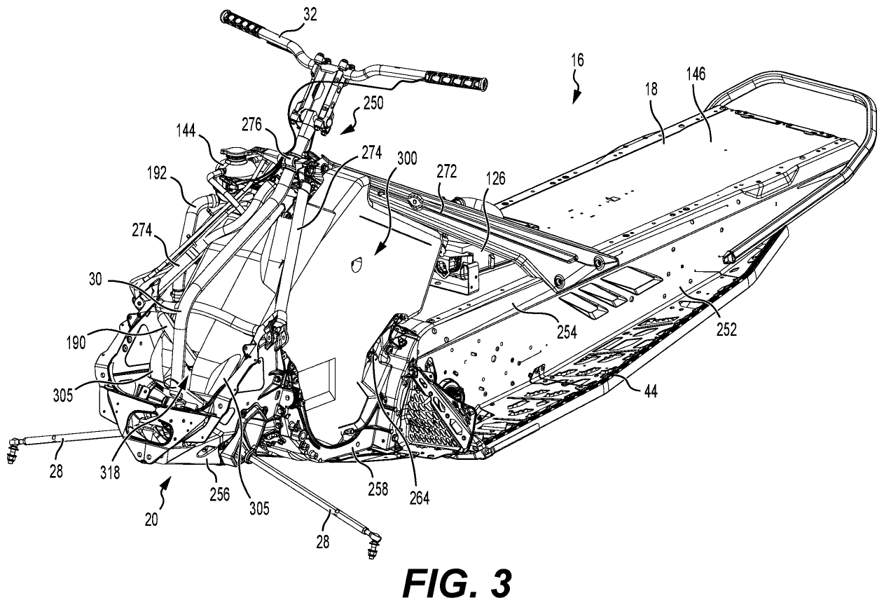

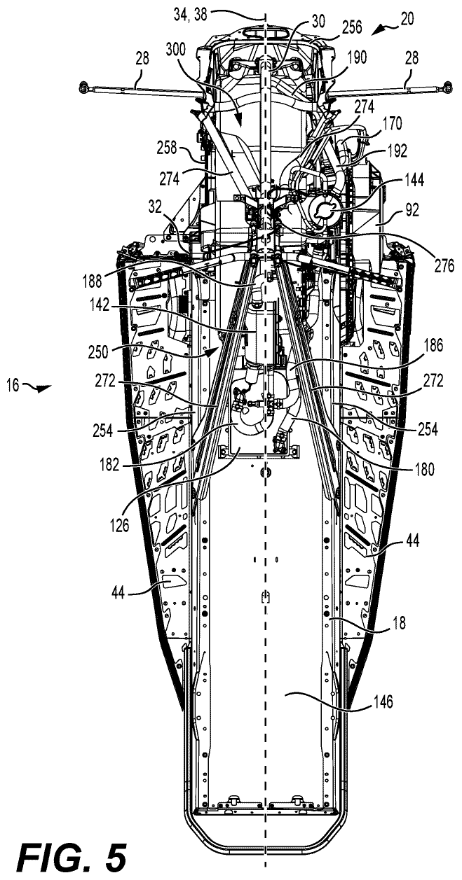

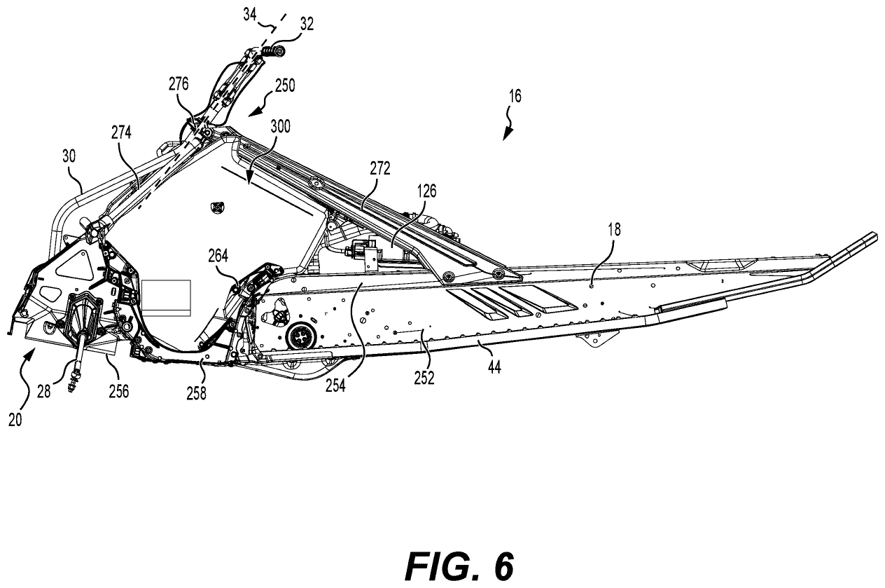

The snowmobile 10 has left and right skis 22 positioned at the front end 12 of the snowmobile 10 and connected to the subframe 20 through left and right front suspension assemblies 24. Left and right ski legs 26, also referred to as spindles, connect the left and right skis 22 to the left and right front suspension assemblies 24 respectively. In the present embodiment, the front suspension assemblies 24 are double A-arm suspension assemblies, but other types of front suspension assemblies are contemplated. As shown in FIG. 2 for the right ski leg 26, the ski legs 26 are connected to steering links 28. With reference to FIG. 3, the steering links 28 are operatively connected to a lower end of a steering column 30. A handlebar 32 is connected to a top end of the steering column 30. Turning the handlebar 32 pivots the steering column 30 about a steering axis 34 (FIG. 6), which in turn pushes or pulls on the steering links 28, which turns the ski legs 26, and thereby the skis 22, which steers the snowmobile 10. In the present embodiment, a plane 38 (FIG. 5) extending vertically and longitudinally along a center of the snowmobile 10 contains the steering axis 34. It is contemplated that in some embodiments, the snowmobile 10 could have only one central ski 22.

A straddle seat 40 is disposed rearward of the handlebar 32 over the tunnel 18 and is connected to the tunnel 18. A passenger backrest 42 is connected to the tunnel 18 and is disposed at the rear of the straddle seat 40. It is contemplated that the backrest 42 could be omitted. Left and right footrests 44 are connected to and extend outward from the tunnel 18. The footrests 44 are vertically lower than the straddle seat 40 to accommodate the driver's and the passenger's feet.

At the front end 12 of the snowmobile 10, fairings 46 are provided that enclose internal components of the snowmobile 10, thereby providing an external shell that not only protects these components of the snowmobile 10, but also make the snowmobile 10 more aesthetically pleasing. The fairings 46 are connected to the frame 16. The fairings 46 include a hood 48 and side panels 50. The side panels 50 can be opened to provide access to the internal components of the snowmobile 10. Headlights 52 are provided in an opening in the fairings 46. A display screen 54 (FIG. 2) is provided under one of the fairings 46 in front of the handlebar 32. The screen 54 is a touch screen that displays information to the driver as well as menus allowing the driver to make various selections regarding the operation of the snowmobile 10 or the information to be displayed. A key receiving post 56 is provided on one of the fairings 46 to receive a digitally encoded key and lanyard 58. The key receiving post 56 is disposed longitudinally between the seat 40 and the steering column 30, but other positions are contemplated. It is contemplate that the key could be a type of key other than a digitally encoded key.

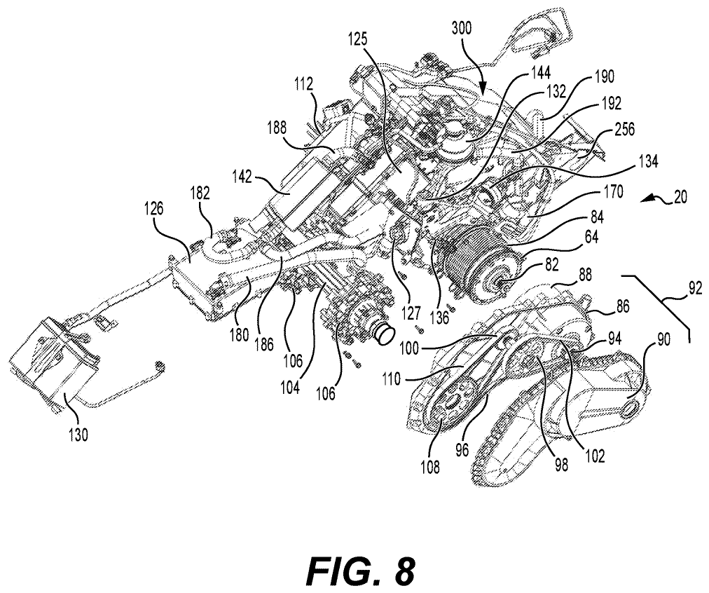

As shown in FIG. 1, a drive track 60 is supported by a rear suspension assembly 62 and is disposed under the tunnel 18. It is contemplated that the drive track 60 could extend rearward of the tunnel 18. The drive track 60 is operatively connected to an electric motor 64 (FIG. 8) which drives the endless drive track 60, as will be described in more detail below.

The rear suspension assembly 62 is connected to the tunnel 18. The rear suspension assembly 62 has front and rear shock absorbers 66, 68. The front shock absorber 66 extends rearwardly and downwardly from a front portion of the tunnel 18 and is disposed between the tunnel 18 and a slide frame assembly 70 of the rear suspension assembly 62 partially forward of front suspension arms 72 of the rear suspension assembly 62. The rear shock absorber 68 extends forwardly and downwardly from a rear portion of the tunnel 18 and is disposed at least in part rearwardly of the front suspension arms 72. The slide frame assembly 70 includes a pair of spaced apart slide rails 74 that engage the inner side of the ground-engaging portion of the drive track 60. As best shown in FIG. 1, the slide frame assembly 70 journals a plurality of rollers 76. In addition, further rollers 78 are carried by the tunnel 18 to define the path over which the drive track 60 travels. Other types of rear suspension assemblies are contemplated.

A snow flap 80 is connected to and extends downward from the rear end of the tunnel 18. The snow flap 80 helps prevent snow and ice from being projected upward behind the snowmobile 10 by the drive track 60 while the snowmobile 10 is in motion. The snow flap 80 also redirects at least some of the snow and ice being projected by the drive track 60 onto the bottom of the tunnel 18 to assist in cooling coolant used for cooling certain components of the snowmobile 10 as will be described in more detail below.

With reference to FIG. 8, the operative connection between the electric motor 64 and the drive track 60 will be described in more detail. The electric motor 64 is a three-phase electric motor 64. The electric motor 64 is mounted to a right side of the subframe 20 and is completely on a right side of the vertical plane 38. An output shaft 82 of the electric motor 64 extends from a right side of a housing 84 of the electric motor 64. An inner cover 86 is placed over the electric motor 64 and is fastened to a right side of the subframe 20 and to a right side of the tunnel 18. The inner cover 86 has a cylindrical portion 88 inside which the electric motor 64 is received. An outer cover 90 is fastened to the inner cover 86 to define a reduction drive housing 92. The output shaft 82 extends through the inner cover 86. A drive sprocket 94 is connected to the end of the output shaft 82. A sprocket shaft 96 is mounted laterally between and is rotationally supported by the inner and outer covers 86, 90. A driven sprocket 98 and a drive sprocket 100 are connected to the sprocket shaft 96. A silent chain 102 is looped around and engages the drive sprocket 94 and the driven sprocket 98. A silent chain is a type of chain that can transmit power at high efficiency, with reduced vibration, and, as its name suggests, with low noise. The sprockets 94, 98 and the silent chain 102 together define a reduction drive, and more specifically a silent chain drive. The snowmobile 10 has a drive axle 104 disposed laterally in a front portion of the tunnel 18. Two drive sprockets 106 are mounted to the drive axle 104. A left end of the drive axle 104 is rotationally supported by the tunnel 18. A right end of the drive axle 104 extends through the inner cover 86 and is rotationally supported thereby. A driven sprocket 108 is connected to the right end of the drive axle 104. A silent chain 110 is looped around and engages the drive sprocket 100 and the driven sprocket 108. The sprockets 100, 108 and the silent chain 110 together define another reduction drive, and more specifically a silent chain drive. The drive sprockets 94, 100, the driven sprockets 98, 108, the silent chains 102, 110, and the sprocket shaft 96 are housed inside the reduction drive housing 92 and together define a reduction drive assembly. It should be noted that both reduction drive assemblies are not provided with chain tensioners. It is contemplated that in some embodiments, the reduction drive assembly could have only one or more than two reduction drives. It is contemplated that in some embodiments, the sprockets 94, 98, 100, 108 and silent chains 102, 110 could be replaced by gears or by pulleys and belts. It is contemplated that in some embodiments, the silent chains 102, 110 could be replaced by another type of flexible drive element such as drive chains or drive belts.

To drive the snowmobile 10, the driver inserts the digitally encoded key onto the key receiving post 56 and then presses a start button (not shown). The driver then selects a drive direction (i.e. forward or reverse) via the touch screen 54. The forward driving direction is selected by default. This determines the direction of rotation of the electric motor 64. It is contemplated that the drive direction could be selected via physical buttons, a switch, a lever, or other means. The key identification, start signal, and drive direction selection are all received by a controller 112 (FIG. 8). The controller 112 includes one or more central processing units (CPUs), and one or more computer readable media. It is contemplated that more than one controller 112 could be provided, in which case different controllers could be responsible for different functions of the snowmobile 10. To accelerate, the driver actuates an accelerator, which in the present embodiment is a thumb-actuated lever 114 (FIG. 2) provided on the right of the handlebar 32. The controller 112 receives a signal from an accelerator position sensor (not shown) that is representative of a position of the thumb-actuated lever 114. Based at least in part on the signal from the accelerator position sensor and the selected drive direction, the controller 112 controls the power delivered to the electric motor 64 to control the speed and direction of turning of the output shaft 82 of the electric motor 64.

The rotation of the output shaft 82 of the electric motor 64 turns the drive sprocket 94. The drive sprocket 94 drives the silent chain 102, which drives the driven sprocket 98. The driven sprocket 98 drives the sprocket shaft 96, which drives the drive sprocket 100. The drive sprocket 100 drives the silent chain 110, which drives the driven sprocket 108. The driven sprocket 108 drives the drive axle 104, which drives the drive sprockets 106. The drive sprockets 106 have radial and axial teeth which respectively engage apertures (not shown) in the drive track 60 and inner lugs (not shown) of the drive track 60, thereby causing the drive track 60 to turn around the rear suspension assembly 62, thereby causing the snowmobile 10 to be propelled forward or rearward depending on the direction of rotation of the drive track 60. Since the diameter of the driven sprocket 98 is larger than the diameter of the drive sprocket 94, and the diameter of the driven sprocket 102 is larger than the diameter of the drive sprocket 100, the drive axle 104 turns slower than the output shaft 82 of the electric motor 64.

To brake the snowmobile 10, the driver actuates a brake lever (not shown) provided on the left of the handlebar 32. This actuates a brake caliper with brake pads (not shown) that engage a brake disc (not shown) mounted on the left end of the drive axle 104. It is contemplated that the electric motor 64 could also provide regenerative braking when the driver releases the thumb-actuated lever 114.

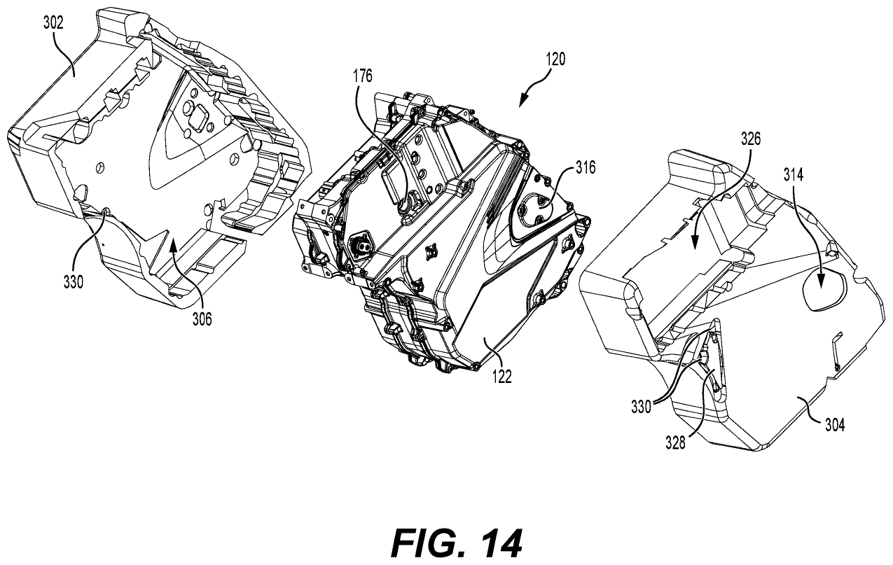

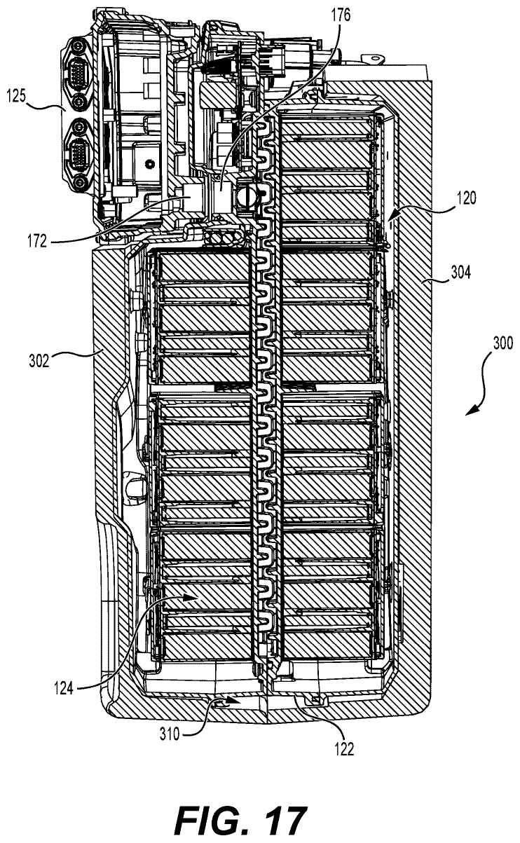

The electric motor 64 is powered by a battery pack 120. The battery pack 120 has a housing 122 containing a plurality of battery cells 124 (see FIG. 17). The maximum output voltage of the battery pack 120 depends on the type and number of battery cells 124 being used. In some embodiments, the maximum output voltage of the battery pack 120 is in a range between 196 volts and 416.5 volts inclusively. The battery pack 120 is disposed in part in the subframe 20, is connected to the subframe 20 and a portion of the subframe 20 extends below the battery pack 120 as will be described in more detail below. As can be understood from FIG. 6, a rear portion of the battery pack 120 extends over a front portion of the tunnel 18. Most of the battery pack 120 is disposed forward of the drive axle 104 (see FIG. 8). As can be understood from FIG. 5, the battery pack 120 is positioned such that the vertical plane 38 passes through the battery pack 120. With reference to FIG. 14, it can be seen that a width of the battery pack 120 is smaller than a height of the battery pack 120 and is smaller than a length of the pack 120. The battery pack 120 is narrower than the handlebar 32. The steering column 30 extends over the battery pack 120. An insulating cover 300 is disposed around the housing 122 to thermally insulate the battery pack 120. The insulating cover 300 is disposed between the fairings 46 and the housing 122 of the battery pack 120. The insulating cover 300 will be described in more detail below.

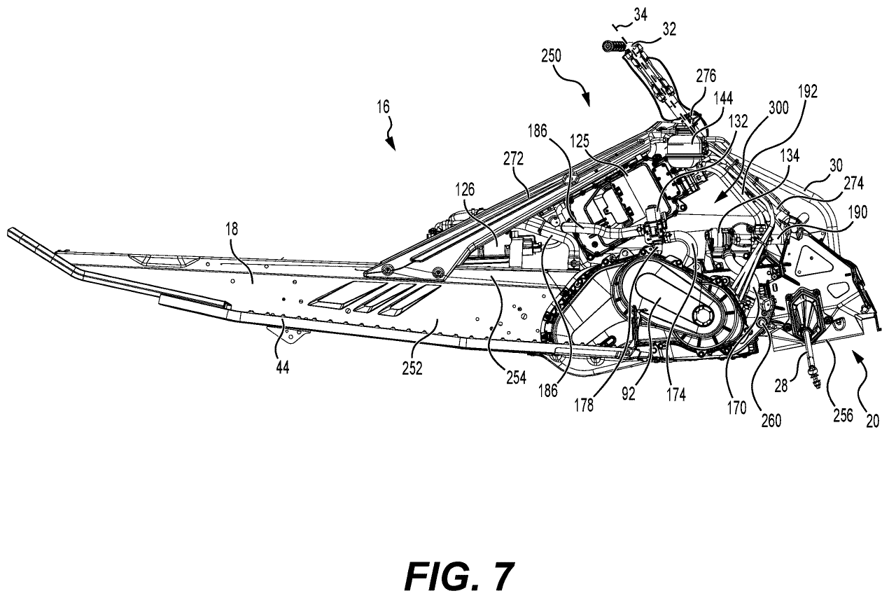

With reference to FIG. 8, the battery pack 120 is electrically connected to an inverter 125 and the inverter 125 is electrically connected to the electric motor 64. The battery pack 120 supplies direct current to the inverter 125. The inverter 125 converts the direct current from the battery pack 120 to alternating current and supplies the alternating current to the electric motor 64. The inverter 125 also converts the alternating current generated by the electric motor 64 during regenerative braking to direct current and supplies this direct current to the battery pack 120 to recharge the battery pack 120. The controller 112 controls the flow of electric current in and out of the battery pack 120 and controls the operation of the inverter 125 such that the output shaft 82 of the electric motor 64 turns in the desired direction and at the desired speed. The inverter 125 is connected to a rear portion of the right side of the battery pack 120 and is disposed above a front portion of the tunnel 18 (see FIG. 7).

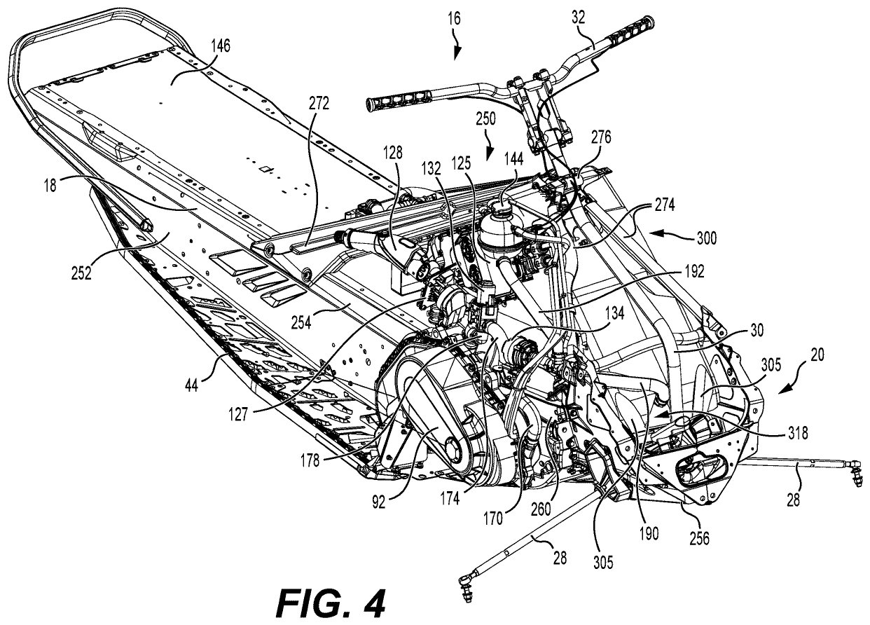

A charger 126 is electrically connected to the battery pack 120. The charger 126 is electrically connected to a charging port 127. In the present embodiment, the charging port 127 is an SAE J1772 AC charging port, but other types of charging ports are contemplated. To recharge the battery pack 120, an external power source is connected to the charging port 127. More specifically, a plug 128 (FIG. 4) from a charging station (not shown) is connected to the charging port 127. The charging station supplies alternating current to the charging port 127. The alternating current is supplied from the charging port 127 to the charger 126. The charger 126 converts this alternating current to direct current and supplies the direct current to the battery pack 120 to recharge the battery pack 120. Instead of a plug 128 from a charging station, it is contemplated that a plug of a mobile power cord connected to a 120 volt or 240 volt power outlet could be plugged in the charging port 127 to power the charger 126. For purposes of the present application, the plug 128 from a charging station will be used in the description provided below, but it should be understood that the plug of a mobile power cord could be also be used. The charger 126 is connected to a top of the tunnel 18 and is disposed under the seat 40. The charging port 127 is connected to the frame 16 and is disposed to the right of the seat 40. As such the charging port 127 is disposed on the right side of the plane 38 and on the same side as the electric motor 64. It is contemplated that the charging port 127 could be disposed on the left side of the seat 40 and the plane 38. A door 129 (FIG. 2) selectively covers the charging port 127. More specifically, the door 129 pivots between a closed position covering the charging port 127 and an open position providing access to the charging port 126. A spring (not shown) biases the door 129 toward the closed position. Embodiments of the door 129 other than the one illustrated are contemplated.

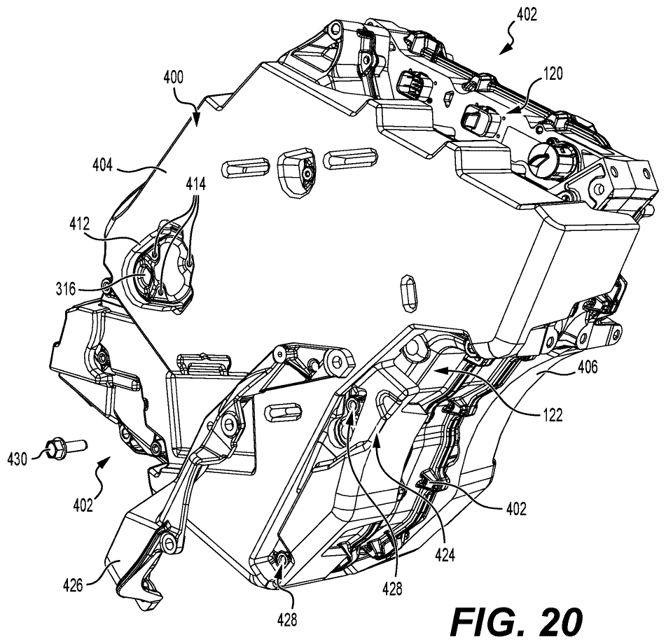

With reference to FIG. 8, the snowmobile 10 is also provided with a secondary battery 130 having a voltage that is lower than the voltage of the battery pack 120. The secondary battery 130 is used to power components of the snowmobile 10 that operate at a lower voltage. In the present embodiment, the secondary battery 130 is a 12-volt battery. The secondary battery 130 is connected to the top of the tunnel 18 behind the charger 126 and is disposed under the seat 40. The secondary battery 130 is electrically connected to the controller 112 to supply direct current to the controller 112 for powering the controller 112. The controller 112 controls the supply of direct current from the secondary battery 130 to the headlights 52 and to the display screen 54. The controller 112 is electrically connected to a valve 132, a pump 134 and a thermistor 136 to supply direct current from the secondary battery 130 to these components for powering and controlling these components. The valve 132, the pump 134 and the thermistor 136 are components of a cooling and heating system 138 (FIGS. 20 to 22) of the snowmobile 10 which will be described in more detail below. It is contemplated that in some embodiment, the thermistor 136 could be replaced by another type of temperature sensor. The controller 112 also supplies direct current from the secondary battery 130 to other components of the snowmobile 10.

The secondary battery 130 is selectively electrically connected to the charger 126. The secondary battery 130 is also selectively electrically connected to the battery pack 120 via a DC-DC converter (not shown). During operation of the snowmobile 10, the secondary battery 130 is disconnected from the charger 126 and is connected to the battery pack 120 via the DC-DC converter such that the secondary battery 130 is recharged by the battery pack 120. The DC-DC converter reduces the voltage of the battery pack 120 to the voltage of the secondary battery 130. When the battery pack 120 is being recharged by an external power source (i.e. plug 128 is plugged into the charging port 127), the secondary battery 130 is connected to the charger 126 and is disconnected from the battery pack 120 such that the secondary battery 130 is recharged by the external power source via the charger 126. The charger 126 has an integrated DC-DC converter (not shown) to supply power to the secondary battery 130 at the appropriate voltage.

The snowmobile 10 also has an electric heater 142 which is part of the cooling and heating system. As the snowmobile 10 generally operates in environments where the temperature is below 0 degree Celsius, the battery pack 120 and other components of the snowmobile 10 need to be heated in order to operate efficiently. The heater 142 is used to heat coolant in the cooling and heating system, and the heated coolant is then supplied to the battery pack 120 and these other components to heat them as will be described in more detail below. The heater 142 is used to heat the battery pack 120 and these other components while the snowmobile 10 is stopped and the battery pack 120 is being recharged (i.e. plug 128 is plugged into the charging port 127). During operation of the snowmobile 10, the heat generated by the electric motor 64 is transferred to the coolant which then heats the battery pack 120 and these other components.

The heater 142 is electrically connected to the charging port 127. The charger 126 and the heater 142 are connected in parallel to the charging port 127. The heater 142 is only turned on by the controller 112 when a signal received by the controller 112 from the thermistor 136 indicates that the temperature of the coolant in the cooling and heating system 138 sensed by the thermistor 136 is below a predetermined temperature T1. In an alternative embodiment, the heater 142 is only turned on by the controller 112 when a signal received by the controller 112 from a battery temperature sensor (not show) indicates that the temperature of the battery pack 120 sensed by the battery temperature sensor is below the predetermined temperature T1. It is also contemplated that instead of being a constant, the predetermined temperature T1 could be a variable determined from an algorithm based on one or more of the temperature of the coolant in the cooling and heating system sensed by the thermistor 136, the temperature of the battery pack 120 sensed by the battery pack temperature sensor, charging requirements, and performance requirements. It is contemplated that other elements could be taken into consideration by such an algorithm. In response to the charging port 127 receiving power from the external power source when the battery pack 120 is being recharged by an external power source (i.e. plug 128 is plugged into the charging port 127) and in response to the thermistor 136 (or battery temperature sensor) sensing a temperature below the temperature T1, the pump 134 is turned on and the heater 142 is powered from the external power source via the charging port 127 such that the heater 142 is turned on and heats the coolant flowing therethrough. In response to the thermistor 136 (or battery temperature sensor) sensing a temperature above the temperature T1, the pump 132 is turned off, and the heater 142 is turned off. Similarly, when the snowmobile 10 is not in operation and the charging port 127 is not receiving power from the external power source (i.e. the plug 128 is not plugged into the charging port 127 or the battery pack 120 is fully charged for example), the pump 132 and the heater 142 are turned off regardless of the temperature sensed by the thermistor 136 (or battery temperature sensor). It is contemplated that when the plug 128 is plugged into the charging port 127, the controller 112 could be programmed to turn on the pump 132 and the heater 142 for a predetermined amount of time at regular intervals to maintain the temperature of the battery pack 120 above the predetermined temperature T1. It is also contemplated that the pump 132 and the heater 142 could be turned on when the snowmobile 10 is started to pre-heat the battery pack 120 and other components in preparation for the operation of the snowmobile 10 while the plug 128 is plugged into the charging port 127. As will be noted, the heater 142 is not connected to the battery pack 120 for receiving power from the battery pack 120. In the present embodiment, the heater 142 is disposed partly over a rear part of the battery pack 120 and the insulating cover 300 and partly over a front part of charger 126. A rear part of the heater 142 is disposed below a front part of the seat 40 and a front part of the heater 142 is disposed in front of the seat 40.

The cooling and heating system will be described in more detail below. It should be noted that since the cooling and heating system is used for both cooling and heating, it may be referred to herein as the cooling system or the heating system depending on its mode of operation.

As can be seen in FIG. 8, the previously described valve 132, pump 134 and thermistor 136 are disposed to the right of the battery pack 120. The pump 134 is disposed above the electric motor 64. The cooling and heating system also includes an expansion tank 144 disposed to the right of the battery pack 120. The expansion tank 144 is at the highest portion of the cooling and heating system.

The cooling system includes a heat exchanger 146. It is contemplated that the heat exchanger 146 could be a heat exchanging unit mounted to a top or a bottom of the tunnel 18. However, in the present embodiment, the heat exchanger 146 defines part of the tunnel 18. More specifically, the heat exchanger 146 defines part of the top of the tunnel 18 and part of the front portion of the tunnel 18. It is contemplated that the heat exchanger 146 could define only part of the top of the tunnel 18 or only part of the front of the tunnel 18. In the present embodiment, the heat exchanger 146 is of the type described in U.S. Pat. No. 10,406,910 , issued on Sep. 10, 2019, the entirety of which is incorporated herein by reference. During operation of the snowmobile 10, the drive track 60 spray snow and ice on portions of a passage (not shown) defined by the heat exchanger 146 to enhance cooling of the coolant flowing in the passage. The snow flap 80 also redirects snow and ice sprayed thereon by the drive track 60 onto portions of the passage of the heat exchanger 146. The charger 126 is connected on top of the heat exchanger 146 such that the charger 126 thermally communicates with the heat exchanger 146. Other embodiments of the heat exchanger 146 are also contemplated.

With reference to FIGS. 4, 5, 7 and 8 the pump 134 is fluidly connected to the motor 64 by a conduit, which in this embodiment is a pipe 170. The motor 64 is fluidly connected to an inlet of the valve 132 by a conduit, which in this embodiment is a pipe 174. The thermistor 136 is connected to the pipe 174 such that the thermistor 136 senses the temperature of coolant flowing from the motor 64 to the inlet of the valve 132, and therefore senses the temperature of the coolant supplied to the inlet of the valve 132. An outlet of the valve 132 is fluidly connected to the inlet of the heat exchanger 146 by a conduit, which in this embodiment is a pipe 178. The outlet of the heat exchanger 146 is fluidly connected to the charger 126 by a conduit, which in this embodiment is a pipe 180. The charger 126 is fluidly connected to the heater 142 by a conduit, which in this embodiment is a pipe 182. Another outlet of the valve 132 is fluidly connected to the heater 142 by a conduit, which in this embodiment is a pipe 186. The heater 142 is fluidly connected to the inverter 125 by a conduit, which in this embodiment is a pipe 188. A conduit of the inverter 125, which in this embodiment is coolant passage 172 of the inverter 125, is fluidly connected to a conduit of the battery pack 120, which in this embodiment is a coolant passage 176 of the battery pack 120 as can be seen in FIG. 17. The battery pack 120 is fluidly connected to the pump 134 by a conduit, which in this embodiment is a pipe 190. The expansion tank 144 is fluidly connected between the pump 134 and the battery pack 120 by a conduit, which in this embodiment is a pipe 192. During operation of the cooling and heating system, should the coolant in the system thermally expand, coolant will flow to the expansion tank 144. Also, during operation of the cooling and heating system, should the coolant in the system thermally contract or should the amount of coolant in the system go down due to a leak, coolant will flow from the expansion tank 144 to the pump 134. The expansion tank 144 is also used to fill the cooling and heating system with coolant. The pump 134 is used to circulate coolant between the various components of the cooling and heating system.

Turning now to FIGS. 3 to 7, 9 and 10, the frame 16 of the snowmobile 10 will be described in more detail. As previously described, the frame 16 has a tunnel 18, a subframe 20 connected to the tunnel 18 and being disposed in front of the tunnel 18, and footrests 44 connected to and extending outward from the tunnel 18. The frame 16 also has a brace assembly 250. The brace assembly 250 is connected to the tunnel 18 and the subframe 20 and extends in part forward of the tunnel 18. As will be described below, the brace assembly 250 is also mounted to the battery pack 120 such that the battery pack 120 forms a structural component of the frame 16.

The tunnel 18 has a top, which is defined by the heat exchanger 146 in the present embodiment, and left and right sides 252. The footrests 44 extend from the lower ends of the sides 152. Each of the sides 252 defines a longitudinally extending beveled surface 254 at its upper end.

The subframe 20 is made of three main parts: a center portion 256, a left side 258 and a right side 260. The center portion 256 extends below the battery pack 120 and the insulating cover 300. The front ends of the left and right sides 258, 260 are fastened to the center portion 256 such that, when viewed from above, the subframe 20 is generally U-shaped. The rear ends of the left and right sides 258, 260 of the subframe 20 are fastened to the front of the tunnel 18. The right side 260 of the subframe 20 defines an aperture through which the electric motor 64 extends. The electric motor 64 is fastened to the right side 260. The inner cover 86 of the reduction drive housing 92 is fastened to the right side 260 of the subframe 20 and to the right side 252 of the tunnel 18.

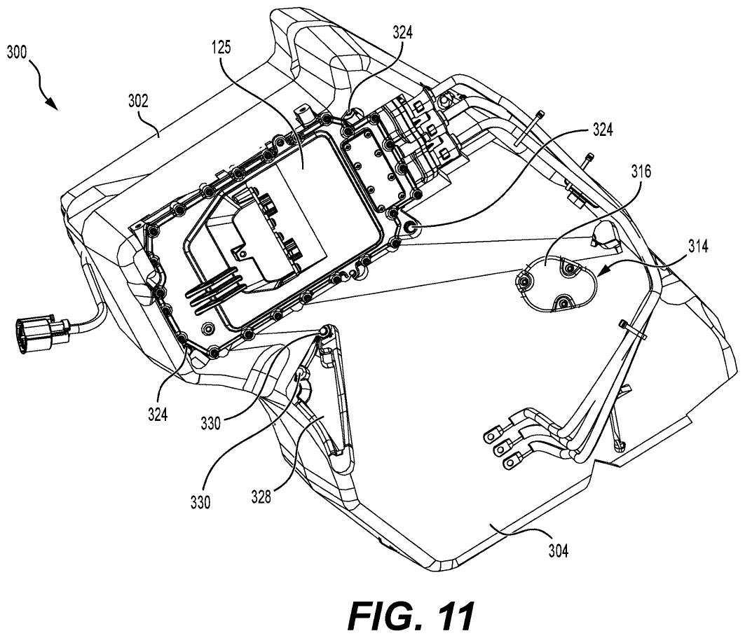

The lower portion of the battery pack 120 is received in a space defined by subframe 20, as best seen in FIG. 11, in front of the tunnel 18. Battery pack 120 is connected to the subframe 20 by battery mounts 264. One battery mount 264 is disposed between the left side 258 of the subframe 20 and the battery pack 120 and connects the battery pack 120 to the left side 258 of the subframe 20. The other battery mount 264 is disposed between the right side 260 of the subframe 20 and the battery pack 120 and connects the battery pack 120 to the right side 260 of the subframe 20. It is contemplated that in some embodiments, there may be more than one battery mount 264 on each side of the battery pack 120 for connecting the battery pack 120 to the corresponding side 258 or 260 of the subframe 20.

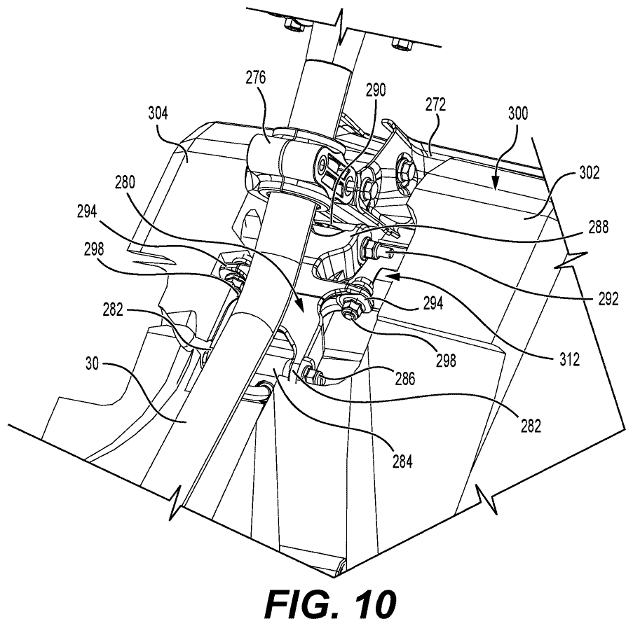

In the present embodiment, the brace assembly 250 is a pyramidal brace assembly 250 having two rear legs 272 and two front legs 274 that connect to a steering column support bracket 276 (best seen in FIG. 10). The steering column 30 passes through and is supported by the steering column support bracket 276 which is disposed above the battery pack 120. The steering column support bracket 276 defines an apex of the pyramidal brace assembly 250. The brace assembly 250 also includes a battery bracket 280 connected between the steering column support bracket 276 and the battery pack 120.

The rear left leg 272 has a rear end connected to the beveled surface 254 of the left side 252 of the tunnel 18 and a front end connected to the steering column support bracket 276. The rear right leg 272 has a rear end connected to the beveled surface 254 of the right side 252 of the tunnel 18 and a front end connected to the steering column support bracket 276. As can be seen, the rear legs 272 extend upward, forward and laterally inward from their rear ends to their front ends. As such, the rear ends of the rear legs 272 are spaced further from each other than the front ends of the rear legs 272. The battery pack 120 is disposed laterally between the rear ends of the rear legs 272. The front ends of the rear legs 272 are disposed over the battery pack 120.

The front left leg 274 has a rear end connected to the steering column support bracket 276 and a front end connected to the center portion 256 of the subframe 20. The front right leg 274 has a rear end connected to the steering column support bracket 276 and a front end connected to the center portion 256 of the subframe 20. As can be seen, the front legs 274 extend downward, forward and laterally outward from their rear ends to their front ends. As such, the front ends of the front legs 274 are spaced further from each other than the rear ends of the front legs 274. The battery pack 120 is disposed laterally between the front ends of the front legs 274. The rear ends of the front legs 274 are disposed over the battery pack 120.

The battery bracket 280 has an arcuate lateral profile. With reference to FIG. 10, the battery bracket 280 has two front bracket arms 282. A portion of a top of the battery pack 120 defines a boss 284 that is received between the two front bracket arms 282. A fastener 286 extends laterally through the front of the front bracket arms 282 and the boss 284 to fasten the front end of the battery bracket 280 to the battery pack 120. The battery bracket 280 has two rear bracket arms 288 (only the left one being visible). A portion of a top of the battery pack 120 defines a boss 290 rearward of the boss 284. The boss 290 is received between the two rear bracket arms 288. A fastener 292 extends laterally through the rear of the rear bracket arms 288 and the boss 290 to fasten the rear end of the battery bracket 280 to the battery pack 120. The middle portion of the battery bracket 280 has left and right laterally extending battery bracket tabs 294. The steering column support bracket 276 has left and right laterally extending steering column support bracket tabs (not shown). The middle portion of the battery bracket 280 is connected to the steering column support bracket 276 by a longitudinally extending left fastener 298 fastening the left steering column support bracket tab to the left battery bracket tab 294 and by a longitudinally extending right fastener 298 fastening the right steering column support bracket tab to the right battery bracket tab 294.

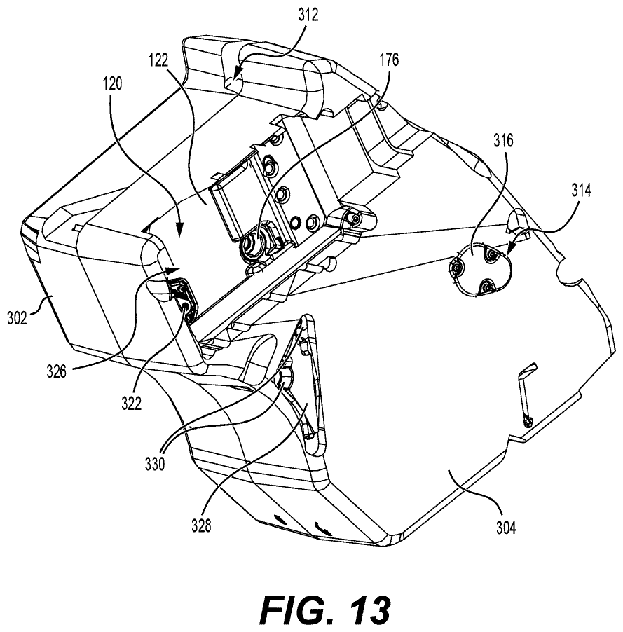

Turning now to FIGS. 11 to 17, the insulating cover 300 will be described in more detail. The insulating cover 300 is disposed around a majority of the housing 122 of the battery pack 120. As will be described below, some areas of the battery pack 120 are not covered by the insulating cover 300 due to apertures defined in the insulating cover 300 to permit the connection of various components to the battery pack 120. In the present embodiment, the insulating cover 300 is made from a polyurethane foam, such as Elastoflex® from the BASF Corporation, and more specifically Elastoflex®V-0 28120 R Resin/Elastoflex®V-0 28120T Isocyanate. Other types of polyurethane foams are contemplated. Other types of thermally insulating foams are also contemplated. It is also contemplated that a thermally insulating material other than foam could be used.

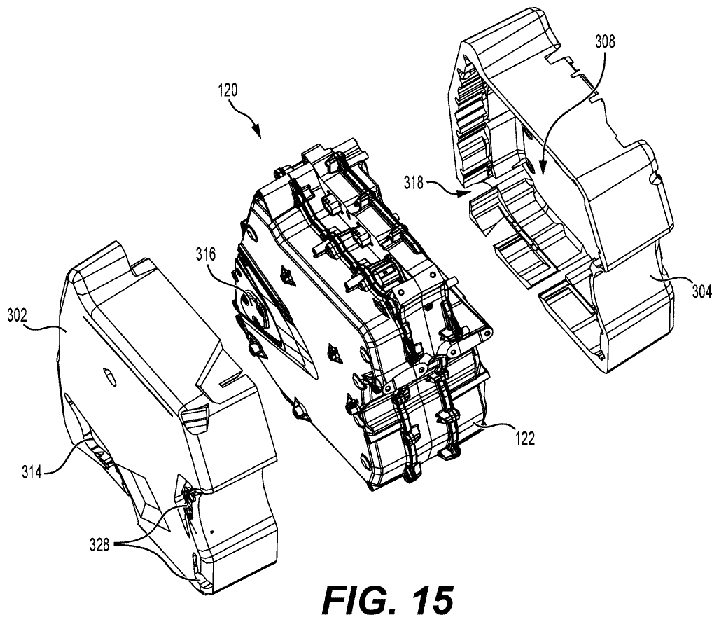

In the present embodiment, the insulating cover 300 is made from two separate parts 302, 304 disposed adjacent to each other. In the present embodiment, the two parts 302, 304 are split longitudinally from each other such that the part 302 is a left part 302 and the part 304 is a right part 304. With reference to FIGS. 14 and 15, the left part 302 defines a left cavity 306 that receives a left portion of the battery pack 120 therein, and the right part 304 defines a right cavity 308 that receives a right portion of the battery pack 120. It is contemplated that in other embodiments the two parts 302, 304 of the insulating cover 300 could be split from each other in a direction other than a longitudinal direction. For example, the parts 302, 304 could be front and rear parts or top and bottom parts. It is also contemplated that the insulating cover 300 could have more than two separate parts. It is also contemplated that the insulating cover 300 could be a single part that is slid over the battery pack 300.

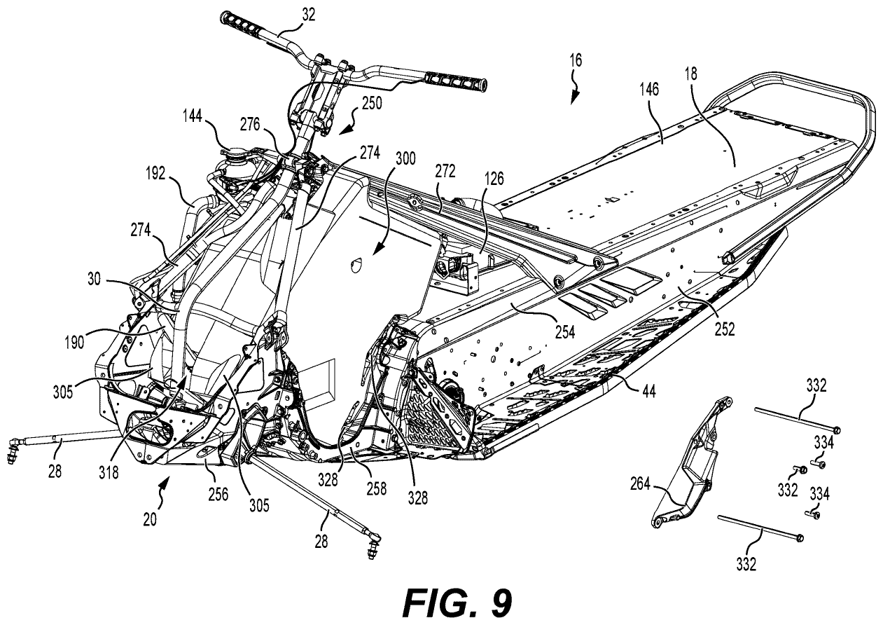

As the battery pack 120 is surrounded by many other components of the snowmobile 10, the outer surface of the insulating cover 300 has many notches and recesses so as not to interfere with these components. For example, as best seen in FIGS. 4 and 9, each part 302, 304 of the insulating cover 300 defines a recess 305 for receiving a portion of the steering column 30 when the steering column 30 is turned for making a left turn or a right turn. The inner surfaces of the left and right parts 302, 304 of the insulating cover 300 are generally congruous with the outer surfaces of the portions of the housing 122 of the battery pack 120 that they cover. As such, the inner surfaces of the left and right parts 302, 304 of the insulating cover 300 generally follow the shape the outer surface of the housing 122 of the battery pack 120 and abut or are close to the outer surface of the housing 122. As can be seen in FIG. 17, a majority of the inner surfaces of the left and right parts 302, 304 of the insulating cover 300 abut the outer surface the housing 122 of the battery pack 120, but in some places, such as in the region 310 (FIG. 17) at the bottom of the battery pack 120, the inner surfaces of the left and right parts 302, 304 are slightly spaced from the outer surface of the housing 122. In some embodiments, a maximum distance between the inner surface of the insulating cover 300 and the outer surface of the housing 122 is less than 5 centimeters. This maximum distance is measured normal to the outer surface of the housing 122. In other embodiments, this maximum distance is less than 3 centimeters. In other embodiments, this maximum distance is less than 1 centimeter. In other embodiments, every portion of the inner surface of the insulating cover 300 abuts the outer surface of the housing 122, such that the inner surface of the insulating cover 300 is congruous with the outer surface of the housing 122, instead of being generally congruous like the inner surface of the insulating cover 300 illustrated in FIG. 17. As a result of the shapes of the inner and outer surfaces of the insulating cover 300, the insulating cover 300 has a variable thickness. In some embodiments, the thickness of the insulating cover 300 varies between 10 centimeters and 2 millimeters. In other embodiments, the thickness of the insulating cover 300 varies between 5 centimeters and 5 millimeters. In other embodiments, the thickness of the insulating cover 300 is 3 centimeters or less.

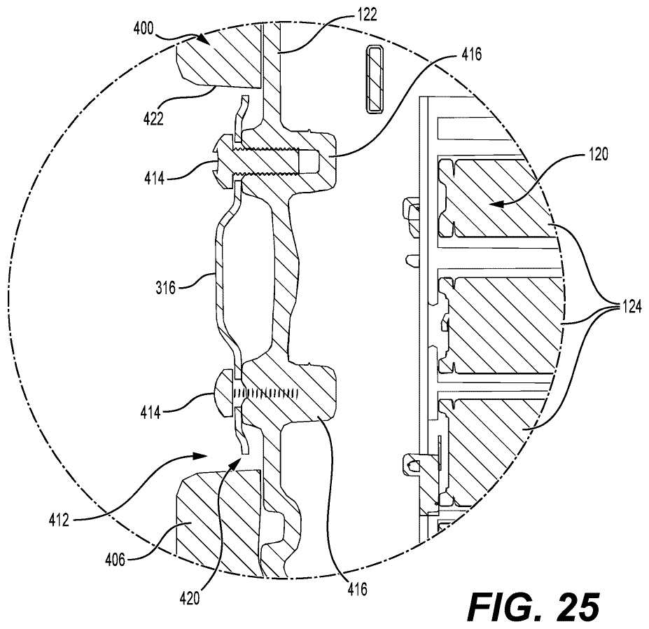

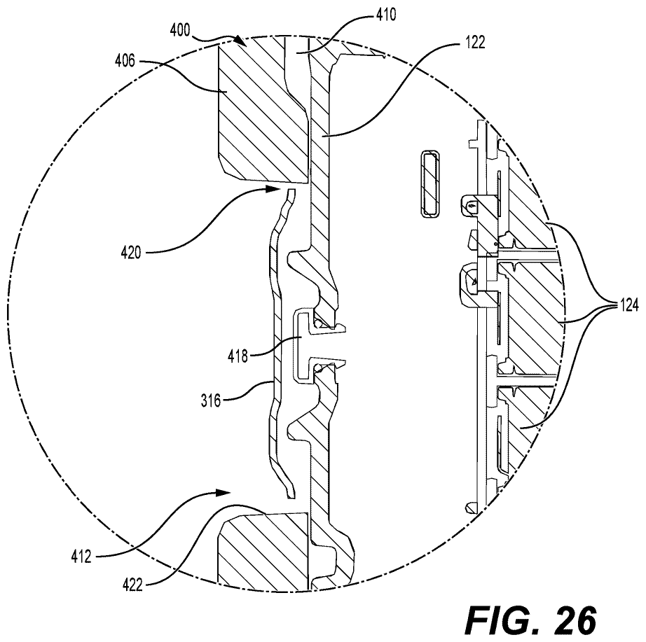

With reference to FIG. 10, the left part 302 of the insulating cover 300 defines a recess at a top thereof which, together with a left upper edge of the right part 304, defines a battery bracket aperture 312 in the insulating cover. The battery bracket 280 extends through the battery bracket aperture 312 to connect the housing 122 of the battery pack 120 to the steering column support bracket 276. Apertures 314 are defined in the left and right parts 302, 304 of the insulating cover 300 to provide clearance around covers 316 provided on the housing 122 of the battery pack 120. The covers 316 divert gases released from inside the housing 122 in the unlikely event of thermal runaway in the battery pack 120. The covers 316 will be described in more detail below with reference to an insulating cover 400 and FIGS. 25 and 26. As can be seen in FIGS. 3 and 4, a conduit aperture 318 is defined in a front lower part of the insulating cover 300 to permit the connection of the pipe 190.

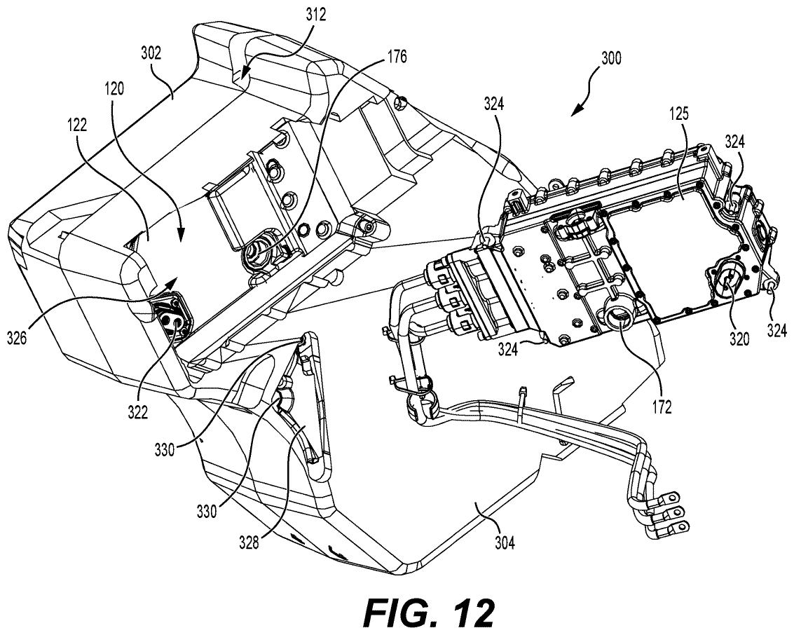

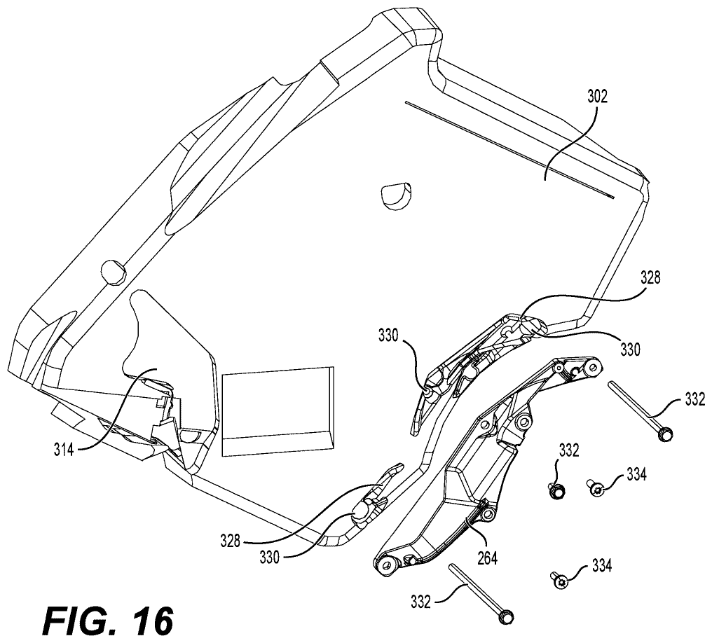

As mentioned above, the inverter 125 is connected to a rear portion of the right side of the battery pack 120 and the coolant passage 172 of the inverter 125 is fluidly connected the coolant passage 176 of the battery pack 120. With reference to FIG. 12, an electric connector 320 electrically connects the inverter 125 to a power plug 322 of the battery pack 120. A number of inverter fasteners 324 (see FIG. 11) connect the inverter 125 to the housing 122 of the battery pack 120. To permit the desired position of the inverter 125 on the housing 122, the fluid connection between the coolant passages 172, 176, the electrical connection between the electric connector 320 and the power plug 322, and the passage of the inverter fasteners 324, the right part 304 of the insulating cover 300 defines an inverter aperture 326. In this embodiment, the inverter aperture 326 is sized such that the inverter 125, the electric connector 320, the coolant passage 172 and the inverter fasteners 324 extend through the inverter aperture 324. As such, in this embodiment, the inverter aperture 324 also combines the functions of a connector aperture for the electric connector 320, a conduit aperture for the coolant passage 172 and fastener apertures for the inverter fasteners 324. It is contemplated that instead of having a single large inverter aperture 326, the right part 304 of the insulating cover 300 could define an inverter recess in which the inverter 125 is received, and that discrete connector, conduit and fastener apertures could be defined in the inverter recess to permit the various connections between the inverter 125 and the battery pack 120. As best seen in FIG. 11, when the inverter 125 is mounted to the housing 122 of the battery pack 120, a portion of the right part 304 of the insulating cover 300 is held between the inverter 125 and the housing 122 In the present embodiment, during manufacturing of the snowmobile 10, the insulating cover 300 is disposed around the housing 122 of the battery pack 120 before the battery pack 120 is mounted to the subframe 20. With reference to FIGS. 9 and 16, the left part 302 of the insulating cover 300 defines recesses 328 that receive parts the battery mount 264. Battery mount apertures 330 are defined in the recesses 328. Battery mount fasteners 332 are inserted through the battery mount 264, extend through the battery mount apertures 330, and are received in the housing 122 to fasten the battery pack 120 to the battery mount 264. As such, a portion of the left part 302 of the insulating cover 300 is held between battery mount 264 and the housing 122. Battery mount fasteners 334 fasten the battery mount 264 to the left side 258 of the subframe 20. It is contemplated that the recesses 328 could be omitted. It is also contemplated that the battery mount apertures could be sufficiently large to receive portions of the battery mount 264 such that the battery mount 264 is in contact with the housing 122. Similarly, although positioned and shaped differently, the right part 304 of the insulating cover 300 has recesses 328 and battery mount apertures 330 to connect the housing 122 to the other battery mount 264 and thereby to the right side 260 of the subframe 20.

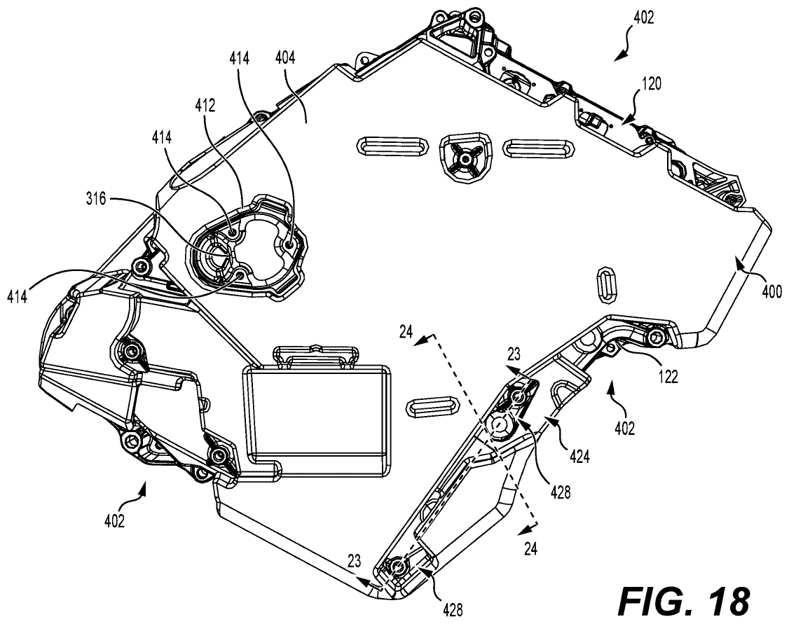

Turning now to FIGS. 18 to 26, an insulating cover 400, which is an alternative embodiment of the insulating cover 300, will be described. The insulating cover 400 is disposed around a majority of the housing 122 of the battery pack 120 to thermally insulate the battery pack 120. In the present embodiment, the insulating cover 400 is made from a polyurethane foam, such as Elastoflex® from the BASF Corporation, and more specifically Elastoflex®V-0 28120R Resin / Elastoflex®V-0 28120T Isocyanate. Other types of polyurethane foams are contemplated. Other types of thermally insulating foams are also contemplated. It is also contemplated that a thermally insulating material other than foam could be used.

In the present embodiment, the insulating cover 400 is made from two separate parts 404, 406 disposed adjacent to each other. In the present embodiment, the two parts 404, 406 are split longitudinally from each other such that the part 404 is a left part 404 and the part 406 is a right part 406. The left part 404 defines a left cavity that receives a left portion of the battery pack 120 therein, and the right part 406 defines a right cavity that receives a right portion of the battery pack 120. It is contemplated that in other embodiments the two parts 404, 406 of the insulating cover 400 could be split from each other in a direction other than a longitudinal direction. For example, the parts 404, 406 could be front and rear parts or top and bottom parts. It is also contemplated that the insulating cover 400 could have more than two separate parts. It is also contemplated that the insulating cover 400 could be a single part that is slid over the battery pack 400.

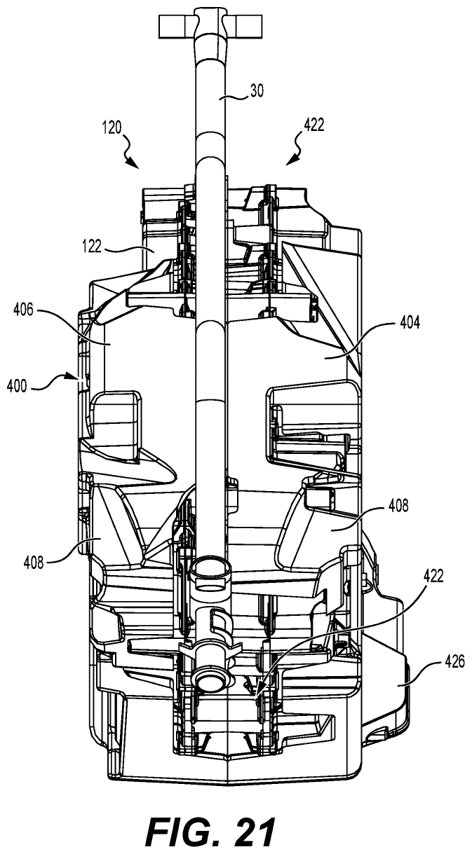

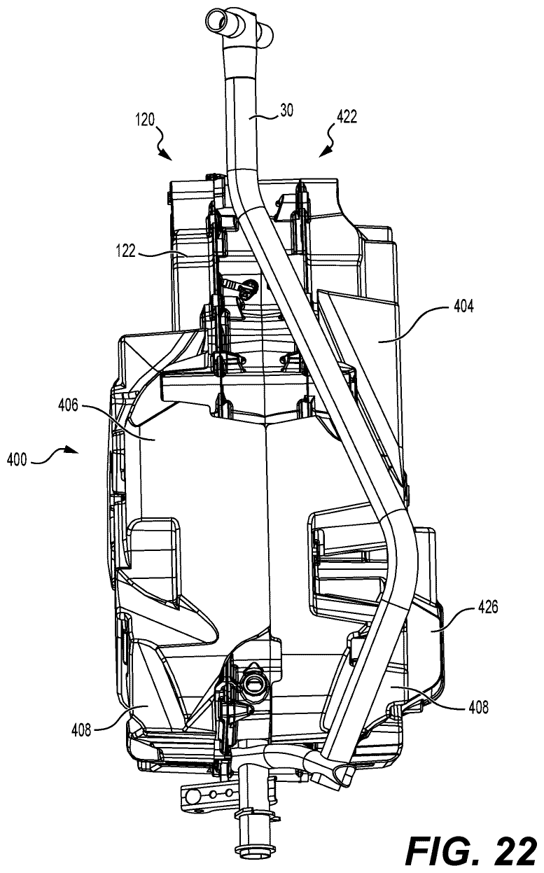

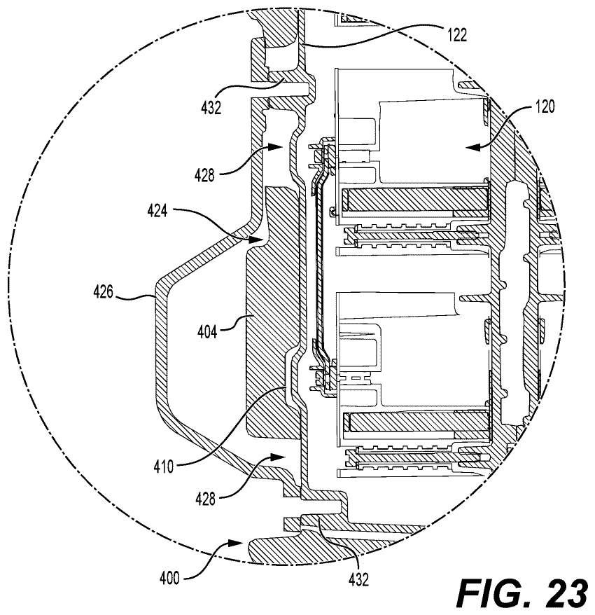

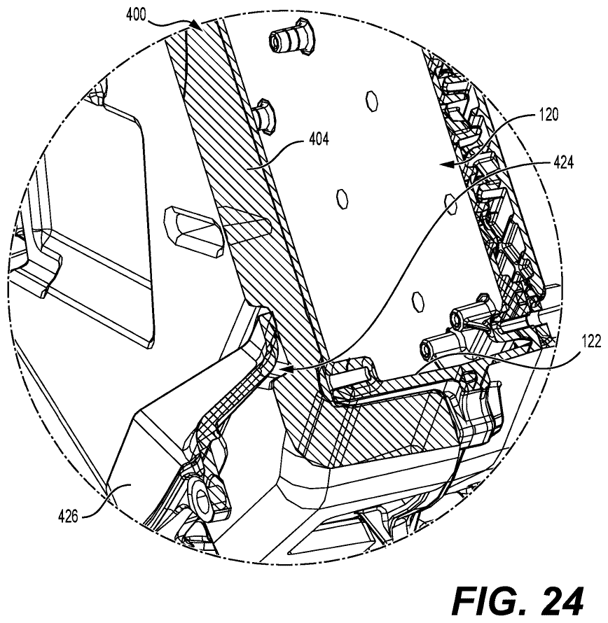

As the battery pack 120 is surrounded by many other components of the snowmobile 10, the outer surface of the insulating cover 400 has many notches and recesses so as not to interfere with these components. For example, as best seen in FIGS. 21 and 22, each part 404, 406 of the insulating cover 400 defines a recess 408 for receiving a portion of the steering column 30 when the steering column 30 is turned for making a left turn (as shown in FIG. 22) or a right turn. The inner surfaces of the left and right parts 404, 406 of the insulating cover 400 are generally congruous with the outer surfaces of the portions of the housing 122 of the battery pack 120 that they cover, as shown in FIG. 24. As such, the inner surfaces of the left and right parts 404, 406 of the insulating cover 400 generally follow the shape the outer surface of the housing 122 of the battery pack 120 and abut or are close to the outer surface of the housing 122. A majority of the inner surfaces of the left and right parts 404, 406 of the insulating cover 400 abut the outer surface the housing 122 of the battery pack 120, but in some places, such as in the region 410 of FIGS. 23 and 26, the inner surfaces of the left and right parts 404, 406 are slightly spaced from the outer surface of the housing 122. In some embodiments, a maximum distance between the inner surface of the insulating cover 400 and the outer surface of the housing 122 is less than 5 centimeters. This maximum distance is measured normal to the outer surface of the housing 122. In other embodiments, this maximum distance is less than 3 centimeters. In other embodiments, this maximum distance is less than 1 centimeter. In other embodiments, every portion of the inner surface of the insulating cover 400 abuts the outer surface of the housing 122, such that the inner surface of the insulating cover 400 is congruous with the outer surface of the housing 122, instead of being generally congruous like the inner surface of the insulating cover 400 illustrated in FIGS. 23 and 26. As a result of the shapes of the inner and outer surfaces of the insulating cover 400, the insulating cover 400 has a variable thickness. In some embodiments, the thickness of the insulating cover 400 varies between 10 centimeters and 2 millimeters. In other embodiments, the thickness of the insulating cover 400 varies between 5 centimeters and 5 millimeters. In other embodiments, the thickness of the insulating cover 400 is 3 centimeters or less.

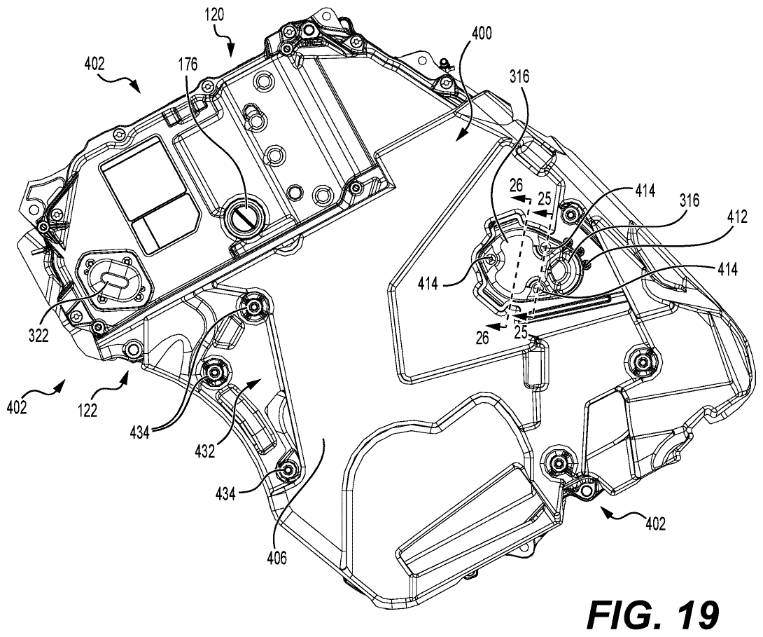

Apertures 412 are defined in the left and right parts 404, 406 of the insulating cover 400 to provide clearance around the covers 316 provided on the housing 122 of the battery pack 120. With reference to FIGS. 19, 25 and 26, the right cover 316 and the right aperture 412 will be described in more detail. The left cover 316 and the left aperture 412 are mirror images if the right cover 316 and of the right aperture 412 and will not be described in detail herein. The cover 316 is fastened to the housing 122 of the battery pack 120 by three screws 414. As seen in FIG. 25 for two of the screws 414, the screws 414 are received in posts 416 defined by the housing 122 so as to create a space between the cover 316 the housing 122. As can be seen in FIG. 26, the cover 316 covers a pressure valve 418. In the unlikely event of thermal runaway in the battery pack 120, the pressure valve 418 opens to release gases from inside the housing 122 to reduce the pressure inside the housing 122. As the cover 316 is disposed in front of the valve 418, the cover 316 diverts gases released through the valve 418 to prevent them to be expelled as a jet. Instead of being expelled as a jet, the gases flow behind the cover 316 and then in a gap 420 formed between the edge of the cover 316 and the wall 422 of the right part 406 of the insulating cover 400 defining the aperture 412. An area of the gap 420 is greater than an area of the passage defined by the valve 418 when it is opened such that the gases pass through the gap 420 at a slower speed than the gases passing through the passage defined by the valve 418.

In the present embodiment, during manufacturing of the snowmobile 10, the insulating cover 400 is disposed around the housing 122 of the battery pack 120 before the battery pack 120 is mounted to the subframe 20. With reference to FIGS. 18, 20, 23 and 24, the left part 404 of the insulating cover 400 defines recesses 424 that receive parts a battery mount 426. The battery mount 426 is an alternative embodiment of the battery mount 264 described above. The battery mount 426 is disposed between the left side 258 of the subframe 20 and the battery pack 120 and connects the battery pack 120 to the left side 258 of the subframe 20. Battery mount apertures 428 are defined in the recesses 424. The battery mount apertures 428 are sufficiently large to receive portions of the battery mount 426 such that the battery mount 426 is in contact with the housing 122 as shown in FIG. 23. Battery mount fasteners 430 (one of which is shown in FIG. 20) are inserted through the battery mount 426, extend through the battery mount apertures 428, and are received in posts 432 (FIG. 23) defined by the housing 122 to fasten the battery pack 120 to the battery mount 426. As such, portions of the left part 404 of the insulating cover 400 are disposed between battery mount 426 and the housing 122, as shown in FIG. 23, and held between battery mount 426 and the housing 122, as shown in FIG. 24. Battery mount fasteners (not shown) fasten the battery mount 426 to the left side 258 of the subframe 20. Similarly, although positioned and shaped differently, the right part 406 of the insulating cover 400 has recesses 432 and battery mount apertures 434 to connect the housing 122 to a right battery mount (not shown) and thereby to the right side 260 of the subframe 20.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. An electric snowmobile comprising:
a frame having a tunnel;
a seat connected to the tunnel;
at least one ski operatively connected to the frame;
a handlebar operatively connected to the at least one ski;
a drive track disposed at least in part under the tunnel;
an electric motor supported by the frame, the electric motor being operatively connected to the drive track;
a battery pack electrically connected to the electric motor, the battery pack comprising:
a housing connected to the frame; and
a plurality of battery cells housed in the housing;
an insulating cover disposed around the housing to thermally insulate the battery pack; and
fairings connected to the frame, the insulating cover being disposed between the fairings and the housing.

2. The electric snowmobile of claim 1, wherein the insulating cover is disposed around a majority of the housing.

3. The electric snowmobile of claim 1, wherein an inner surface of the insulating cover is congruous or generally congruous with an outer surface of the housing.

4. The electric snowmobile of claim 3, wherein a maximum distance between the inner surface of the insulating cover and the outer surface of the housing is less than 5 centimeters, the maximum distance being measured normal to the outer surface of the housing.

5. The electric snowmobile of claim 1, wherein the insulating cover defines at least one aperture.

6. The electric snowmobile of claim 5, further comprising:
a battery mount connected to the frame; and
a battery mount fastener connecting the battery mount to the housing; and
wherein:
the at least one aperture comprises a battery mount aperture; and
at least one of the battery mount and the battery mount fastener extends through the battery mount aperture.

7. The electric snowmobile of claim 6, wherein a portion of the insulating cover is held between the battery mount and the housing.

8. The electric snowmobile of claim 5, further comprising a steering column operatively connecting the handlebar to the at least one ski; and
wherein:
the frame comprises:
a steering column support bracket supporting the steering column; and
a battery bracket connected between the steering column support bracket and the housing;
the at least one aperture comprises a battery bracket aperture; and
the battery bracket extends through the battery bracket aperture.

9. The electric snowmobile of claim 5, further comprising:
a heat exchanger; and
a conduit fluidly connecting the heat exchanger to the battery pack; and
wherein:
the at least one aperture comprises a conduit aperture; and
the conduit extends through the conduit aperture.

10. The electric snowmobile of claim 9, wherein:
the conduit is a first conduit;
the electric snowmobile further comprises:
an inverter electrically connected to the plurality of battery cells, the first conduit fluidly connecting the inverter to the battery pack; and
a second conduit fluidly connecting the heat exchanger to the inverter; and
the inverter defines a third conduit fluidly connecting the second conduit to the first conduit.

11. The electric snowmobile of claim 10, wherein the inverter is mounted to the housing.

12. The electric snowmobile of claim 5, wherein the battery pack comprises:
a pressure valve connected to the housing, the pressure valve being configured for selectively opening to release gases from inside the housing; and
a cover connected to the housing, the cover covering the pressure valve, a space being defined between the housing and the cover; and
wherein the at least one aperture is an aperture surrounding the cover, a wall of the insulating cover defining the aperture being spaced from an edge of the cover to define a gap therebetween.

13. The electric snowmobile of claim 5, further comprising:
an inverter mounted to the housing;
an electric connector electrically connecting the inverter to the plurality of battery cells; and
an inverter fastener connecting the inverter to the housing; and
wherein:
the at least one aperture comprises an inverter aperture; and
at least one of the inverter, the electric connector and the inverter fastener extends through the inverter aperture.

14. The electric snowmobile of claim 13, wherein the inverter, the electric connector and the inverter fastener extend through the inverter aperture.

15. The electric snowmobile of claim 13, further comprising:
a heat exchanger;
a first conduit fluidly connecting the heat exchanger to the inverter; and
a second conduit fluidly connecting the inverter to the battery pack; and
wherein:
the inverter defines a third conduit fluidly connecting the second conduit to the first conduit; and
the second conduit extends through the inverter aperture.

16. The electric snowmobile of claim 1, further comprising a steering column operatively connecting the handlebar to the at least one ski; and
wherein the insulating cover defines at least one recess, the at least one recess being configured for receiving a portion of the steering column when the steering column is turned to steer the snowmobile.

17. The electric snowmobile of claim 1, wherein:
the insulating cover comprises a first part and a second part separate from the first part;
the first part is adjacent to the second part;
the first part defines a first cavity receiving a first portion of the battery pack therein; and
the second part defines a second cavity receiving a second portion of the battery pack therein.

18. The electric snowmobile of claim 17, wherein:
the first and second parts of the insulating cover are longitudinally split from each other;
the first part is a left part of the insulating cover; and
the second part is a right part of the insulating cover.

19. (canceled)

20. (canceled)

21. The electric snowmobile of claim 1, wherein:
the frame includes a subframe connected to the tunnel and disposed in front of the tunnel;
the battery pack is disposed at least in part in the subframe; and
the housing is connected to the subframe.

22. The electric snowmobile of claim 21, wherein at least a portion of the subframe extends below the battery pack and the insulating cover.
